(19) United States
(12) Patent Application Publication
(10) Pub. No.: US 2024/0169419 A1
(43) Pub. Date: May 23, 2024

(54) Leasing Method and Lease System, and Computer Apparatus

(71) Applicant: TOYOTA JIDOSHA KABUSHIKI KAISHA, Toyota-shi (JP)

(72) Inventors: Yasuhide KURIMOTO, Kasugai-shi (JP); Tomoyoshi UEKI, Toyota-shi (JP); Yuko TERASAWA, Meguro-ku (JP); Masahiro KAGAMI, Nagoya-shi (JP); Hiroshi YAMASAKI, Nagoya-shi (JP); Kenji ZAITSU, Nisshin-shi (JP); Yoshihiko ENDO, Minato-ku (JP)

(21) Appl. No.: 18/492,100

(22) Filed: Oct. 23, 2023

(30) Foreign Application Priority Data
Nov. 18, 2022 (JP) 2022-184751

(51) Int. Cl. G06Q 30/0645; G01R 31/392

(52) U.S. Cl. CPC G06Q 30/0645; G01R 31/392

(57) ABSTRACT

A leasing method includes obtaining first data representing a history of a current that flows in a power storage mounted on a vehicle, obtaining second data representing a history of an amount of accelerator operation in the vehicle, obtaining third data representing a travel distance or a time period of travel of the vehicle, obtaining an accident risk of the vehicle based on the first data, the second data, and the third data, and obtaining a degree of exhaustion of a consumable including the power storage based on the first data, the second data, and the third data, the consumable being provided to the vehicle by lease.

### CROSS REFERENCE TO RELATED APPLICATIONS

This nonprovisional application is based on Japanese Patent Application No. 2022-184751 filed with the Japan Patent Office on Nov. 18, 2022, the entire contents of which are hereby incorporated by reference.

### BACKGROUND

### Field

The present disclosure relates to a leasing method and a lease system, and a computer apparatus.

### Description of the Background Art

Japanese Patent Laying-Open No. 2020-177652 discloses such a technique that a server that manages a rental fee paid by a user for rental of a battery for travel mounted on a vehicle collects a full charge capacity of a battery from the vehicle and lowers the rental fee as the collected full charge capacity decreases.

### SUMMARY

In the technique described in Japanese Patent Laying-Open No. 2020-177652, a value of the power storage lowers as the full charge capacity of the power storage decreases due to exhaustion (deterioration) of the power storage. Therefore, the rental fee is lowered as the full charge capacity decreases. Japanese Patent Laying-Open No. 2020-177652, however, has not sufficiently discussed possibility of failure of a rented power storage due to an accident of the vehicle. When the rented power storage fails due to the accident of the vehicle, a leasing company which is an owner of the power storage sustains damages.

The present disclosure was made to solve the problem above, and an object thereof is to facilitate appropriate provision of a lease service.

According to a form according to a first point of view of the present disclosure, a leasing method shown below is provided.

(Clause 1) The leasing method includes obtaining first data representing a history of a current that flows in a power storage mounted on a vehicle, obtaining second data representing a history of an amount of accelerator operation in the vehicle, obtaining third data representing a travel distance or a time period of travel of the vehicle, obtaining an accident risk of the vehicle based on the first data, the second data, and the third data, and obtaining a degree of exhaustion of a consumable including the power storage based on the first data, the second data, and the third data, the consumable being provided to the vehicle by lease.

A consumable provided to a vehicle by lease may be referred to as a “leased consumable” below. A degree of exhaustion of the leased consumable may be referred to as a “degree of lease exhaustion.” The method facilitates appropriate obtainment of the accident risk of the vehicle and the degree of lease exhaustion. The accident risk represents possibility that the vehicle is involved in an accident. The leased consumable in the method includes a power storage mounted on a vehicle. A history of a current (a charging current or a discharging current) that flows in the power storage, a history of an amount of accelerator operation in the vehicle, and a travel distance or a time period of travel of the vehicle may affect both of the degree of lease exhaustion and the accident risk. For example, in a vehicle driven with such a rough accelerator operation as increasing the accident risk, variation in current in the power storage is more violent and the power storage tends to be exhausted. In addition, as the travel distance or the time period of travel of the vehicle is longer, each of the accident risk and the degree of lease exhaustion tends to increase. Therefore, according to the method, the accident risk and the degree of lease exhaustion can properly be obtained with a small amount of data. The leasing company can know a current value of the leased consumable and possibility of deterioration (or failure) of the leased consumable in the future, and more readily appropriately provide the lease service.

The vehicle including the power storage may be an electrically powered vehicle (xEV) that uses electric power as the entirety or a part of a motive power source. Examples of the xEV include a battery electric vehicle (BEV), a hybrid electric vehicle (HEV), a plug-in hybrid electric vehicle (PHEV), and a fuel cell electric vehicle (FCEV). The leased consumable may include, in addition to the power storage, at least one of a tire, a brake component (for example, a brake pad), and oils (for example, lubricating oil, hydraulic fluid, or refrigerant).

The leasing method according to Clause 1 may be configured according to Clause 2 or 3 shown below.

(Clause 2) The leasing method according to Clause 1 further includes a feature below. The leasing method further includes determining a lease-associated cost based on the accident risk and the degree of lease exhaustion. The lease-associated cost includes an insurance fee paid by a user of the vehicle for reception of an insurance service relating to replacement of the power storage and a lease fee paid by the user of the vehicle for rental of the leased consumable. The determining a lease-associated cost includes setting the insurance fee to be more inexpensive as the accident risk of the vehicle is lower and setting the lease fee to be more inexpensive as the degree of lease exhaustion is higher.

The power storage mounted on the vehicle fails due to an accident, or is deteriorated (exhausted) by being used. The power storage that is no longer able to exhibit sufficient performance due to failure or deterioration may be replaced. In the method, a user of the vehicle can be provided with a substitute power storage, for example, at no charge (or only with a prescribed commission fee) under coverage by the insurance service. In the method, by varying an insurance fee (for example, a monthly insurance fee) in accordance with the accident risk, a compensation for the risk taken by the leasing company can be reflected on the insurance fee. In the method, by varying a lease fee (for example, a monthly lease fee) in accordance with the degree of lease exhaustion, the value (depreciation) of the leased consumable can be reflected on the lease fee.

(Clause 3) The leasing method according to Clause 1 or 2 further includes a feature below. The obtaining a degree of exhaustion of the consumable includes obtaining the degree of exhaustion of the power storage when a body portion except for the power storage of the vehicle is a property of a user of the vehicle and the power storage of the vehicle is provided to the vehicle by lease and obtaining the degree of exhaustion of the power storage and the degree of exhaustion of each consumable included in the body portion when both of the body portion of the vehicle and the power storage are provided to the vehicle by lease.

A vehicle, a body portion (a portion except for the power storage) of which is a property of the user and a power storage of which is provided to the user by lease, is referred to as a “partial lease vehicle” below. A vehicle, both of the body portion and the power storage of which are provided to the user by lease, is referred to as a “full lease vehicle.” According to the method, appropriate obtainment of the degree of exhaustion of the leased consumable for each of the partial lease vehicle and the full lease vehicle is facilitated.

According to one form, a program that causes a computer to perform the leasing method according to any one of Clauses 1 to 3 is provided. In another form, a computer apparatus that distributes the program is provided.

According to a form according to a second point of view of the present disclosure, a computer apparatus shown below is provided.

(Clause 4) The computer apparatus includes a processor and a storage where a program causing the processor to perform the leasing method according to any one of Clauses 1 to 3 is stored.

According to the computer apparatus, the leasing method described previously is suitably performed.

The computer apparatus according to Clause 4 may be configured according to any one of Clauses 5 to 7 shown below.

(Clause 5) The computer apparatus according to Clause 4 further includes a feature below. In the storage, a first trained model and a second trained model are further stored. The first trained model is a model machine-trained to output the accident risk assessed in connection with a first period when the first trained model receives input of first input data including the first data, the second data, and the third data during the first period. The second trained model is a model machine-trained to output a degree of progress of exhaustion of the consumable during a second period when the second trained model receives input of second input data including the first data, the second data, and the third data during the second period. The computer apparatus obtains the degree of exhaustion of the consumable based on the degree of progress of exhaustion of the consumable outputted from the second trained model.

With the use of the first trained model and the second trained model, each of the accident risk of the vehicle and the degree of exhaustion of the leased consumable can highly accurately be obtained. The degree of progress of exhaustion of the consumable during the second period represents a degree of exhaustion of the consumable during the second period. The first period and the second period may be the same period or different periods.

(Clause 6) The computer apparatus according to Clause 5 further includes a feature below. Each of the first period and the second period is an assessment period set before a lease period. The computer apparatus is configured to set a lease fee for the lease period to be more inexpensive as the accident risk of the consumable outputted from the first trained model is lower, set the lease fee for the lease period to be more inexpensive as the degree of progress of exhaustion of the consumable outputted from the second trained model is lower, and set the lease fee for the lease period to be more inexpensive as the degree of exhaustion of the consumable is higher.

According to the method, the lease fee on which the accident risk of the vehicle, the degree of progress of exhaustion of the leased consumable, and the degree of exhaustion of the leased consumable are reflected can be obtained. By varying the lease fee in accordance with the accident risk, a compensation for the risk taken by the leasing company can be reflected on the lease fee. By varying the lease fee in accordance with the degree of exhaustion of the leased consumable, a depreciation of the leased consumable can be reflected on the lease fee. By setting a higher lease fee as the degree of progress of exhaustion of the leased consumable is higher, excessive exhaustion of the leased consumable can be suppressed.

(Clause 7) In the computer apparatus according to Clause 5 or 6, the second input data further includes fourth data representing a history of an outdoor temperature of the vehicle.

Addition of the fourth data as the second input data (input data for the second trained model) facilitates highly accurate estimation of the degree of progress of exhaustion of the leased consumable.

According to a form according to a third point of view of the present disclosure, a lease system shown below is provided.

(Clause 8) The lease system incudes the computer apparatus according to any one of Clauses 4 to 7 and a vehicle that transmits the first data, the second data, and the third data to the computer apparatus.

According to the lease system, the leasing method described previously is suitably performed.

(Clause 9) The lease system according to Clause 8 further includes a plurality of replacement stations where a power storage for a vehicle is replaced. The computer apparatus is configured to permit at least one replacement station, when a degree of exhaustion of a power storage mounted on the vehicle becomes equal to or more than a prescribed value, to replace the power storage.

According to the system, when the degree of exhaustion of the power storage mounted on the vehicle becomes high, replacement of the power storage by a vehicle user at the replacement station is facilitated.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram for illustrating overview of a lease system according to an embodiment of the present disclosure.

FIG. 2 is a diagram for illustrating a configuration of a vehicle shown in FIG. 1.

FIG. 3 is a diagram for illustrating information managed by a computer apparatus (server) according to the embodiment of the present disclosure.

FIG. 4 is a diagram for illustrating a method of obtaining a lease fee in a leasing method according to the embodiment of the present disclosure.

FIG. 5 is a diagram for illustrating a first trained model and a second trained model shown in FIG. 4.

FIG. 6 is a diagram for illustrating a method of generating the first trained model and the second trained model shown in FIG. 4.

FIG. 7 is a flowchart showing processing involved with determination of a lease fee in the leasing method according to the embodiment of the present disclosure.

FIG. 8 is a flowchart showing processing involved with battery management in the leasing method according to the embodiment of the present disclosure.

FIG. 9 is a flowchart showing processing involved with battery replacement performed by a vehicle and a terminal at a replacement station in the leasing method according to the embodiment of the present disclosure.

FIG. 10 is a diagram for illustrating a configuration and an operation of a replacement station included in the lease system according to the embodiment of the present disclosure.

FIG. 11 is a diagram showing a modification of the second trained model shown in FIG. 5.

### DESCRIPTION OF THE PREFERRED EMBODIMENTS

An embodiment of the present disclosure will be described in detail with reference to the drawings. The same or corresponding elements in the drawings have the same reference characters allotted and description thereof will not be repeated.

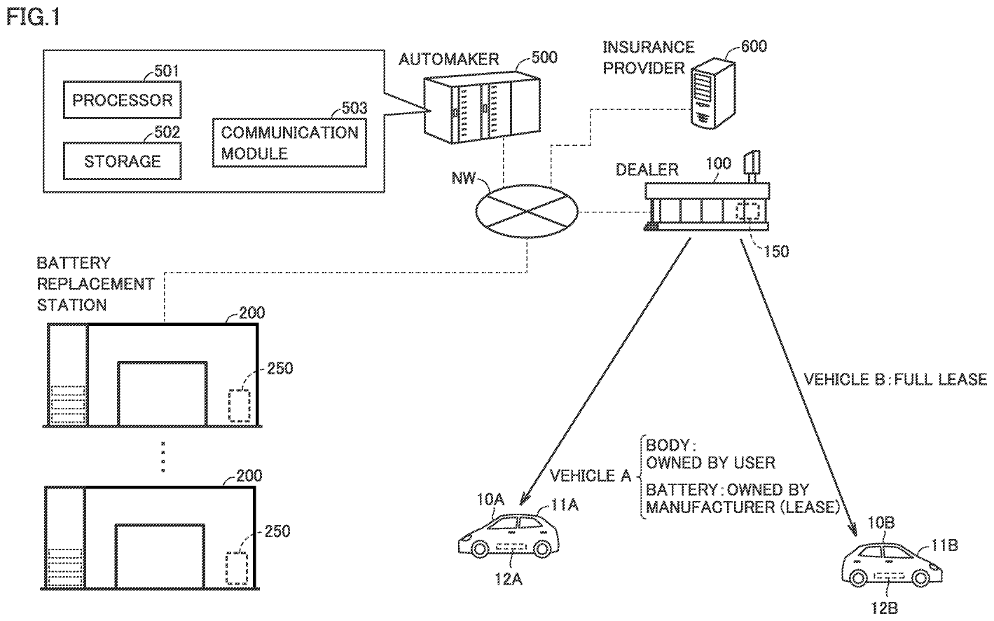

FIG. 1 is a diagram for illustrating overview of a lease system according to this embodiment. The lease system shown in FIG. 1 includes a dealer 100, a battery replacement station (which is denoted as “BSta” below) 200, a management center 500, and an insurance server 600.

Management center 500 is a server that provides a lease service relating to a car. Management center 500 manages information on the lease service. Management center 500 belongs, for example, to an automaker. In this embodiment, the automaker also serves as a leasing company. Insurance server 600 is a server that provides an insurance service. Insurance server 600 manages information on the insurance service. Insurance server 600 belongs, for example, to an insurance provider. Insurance server 600 is in coordination with management center 500 to provide the insurance service relating to a battery rented under the lease service.

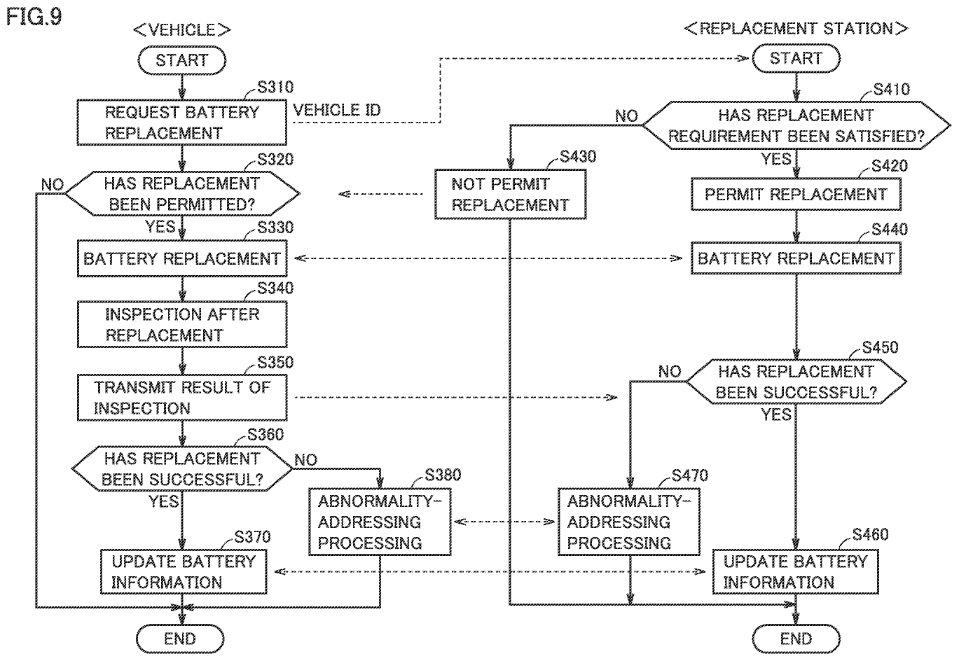

The insurance service refers to an insurance service relating to replacement of the battery, and more particularly to a service for exemption of at least a part of compensation liability of a user who has caused deterioration or failure of a rented battery. An insurance relating to such replacement of a battery is also referred to as a “battery insurance” below. In this embodiment, the user is covered by the battery insurance, so that the entire compensation liability of the user for an owner (that is, the leasing company) of the battery is exempted. More specifically, the user can be provided with a substitute battery at no charge under coverage by the battery insurance when the user has caused deterioration or failure of the rented battery. The user can detach the deteriorated or failed battery from the vehicle, for example, at BSta 200, and attach a new battery (a less deteriorated battery) provided by BSta 200 to the vehicle. The user who purchased the battery insurance, however, is not always covered by the battery insurance. The user who purchased the battery insurance can be covered by the battery insurance only when the user satisfies a prescribed replacement requirement. The replacement requirement will be described later (see S410 in FIG. 9).

In the lease service, a plurality of lease types including a partial lease type and a full lease type are adopted. The partial lease type refers to a lease type for rental only of a battery (more specifically, a drive battery). A user who rents the battery in accordance with the partial lease type prepares by the user himself/herself, a portion (body portion) of the vehicle except for the battery. The user can mount the battery rented from the leasing company on the body owned by the user himself/herself. As the battery is mounted on the body, the xEV can travel. When a partial lease contract is terminated, the user returns only the battery to the leasing company. The full lease type, on the other hand, refers to a lease type for rental of the entire vehicle (that is, both of a body portion and a battery). When a full lease contract is terminated, the user returns not only the battery but also the entire vehicle to the leasing company.

The automaker provides vehicles manufactured thereby to clients (vehicle users) through dealer 100. Dealer 100 includes a server 150. Server 150 manages information (vehicle information) on a vehicle provided by dealer 100, as being distinguished based on a vehicle ID. In response to a request from management center 500 or each time vehicle information is updated, server 150 transmits latest vehicle information to management center 500.

Dealer 100 rents at least one of the body and the battery provided by the automaker. Dealer 100 may rent a battery 12A of a vehicle 10A shown in FIG. 1 to a user, for example, in accordance with the partial lease type. In this case, vehicle 10A corresponds to a partial lease vehicle (which may be denoted as a “vehicle A” below) and a body 11A of vehicle 10A is a property of the user. Battery 12A of vehicle 10A is provided to the user by lease and it is a property of the automaker. Alternatively, dealer 100 may rent a vehicle 10B shown in FIG. 1 to a user, for example, in accordance with the full lease type. In this case, vehicle 10B corresponds to a full lease vehicle (which may be denoted as a “vehicle B” below). The entire vehicle 10B (a body 11B and a battery 12B) is provided to the user by lease and it is a property of the automaker.

In this embodiment, insurance server 600 provides an insurance service relating to repair of the body in addition to the insurance service relating to replacement of the power storage described previously. The insurance service relating to repair of the body is a service to exempt at least a part of compensation liability of the user who has caused damage or failure of the rented body. Such an insurance relating to repair of the body is also referred to as a “body insurance” below. The user of vehicle A purchases the battery insurance but does not purchase the body insurance. The user of vehicle B purchases both of the battery insurance and the body insurance.

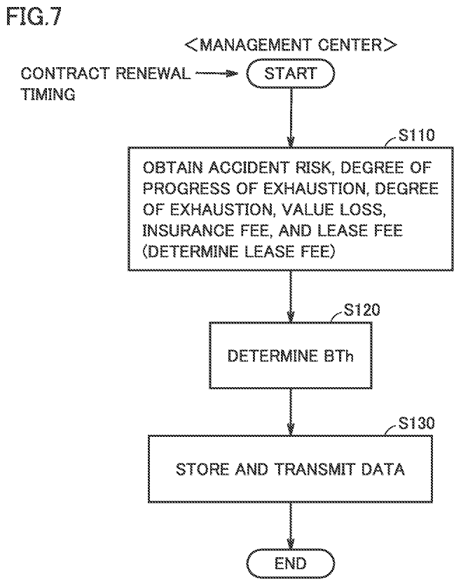

In this embodiment, an insurance fee for an insurance for lease is included in a lease fee. A vehicle user who has made a lease contract with a leasing company can receive the lease service and the insurance service described previously for a prescribed unit period by paying a lease fee for the unit period. Though details will be described later, management center 500 determines the lease fee for each unit period in this embodiment (see FIG. 7). A period for which the fee for reception of the service is paid corresponds to a service period. The service period common to the lease service and the insurance service is referred to as a “lease period” below. In this embodiment, a length (unit period) of the lease period is set to one month.

BSta 200 is configured to replace a battery for a vehicle (for example, for an xEV). BSta 200 includes a server 250. The lease system according to this embodiment includes a plurality of BSta's 200. These BSta's 200 are provided at points within an area under management by the lease system so as to construct a network of battery replacement points that cover the entire area under management thereby. Each BSta 200 may function as a vehicle repair factory. Each BSta may be configured to repair the body. Though only a single dealer 100 is shown in FIG. 1, the system may include a plurality of dealers 100. These dealers 100 may be provided at points within the area under management by the lease system so as to construct a network of lease points that covers the entire area under management thereby. Dealer 100 and BSta 200 may be provided at the same location (or nearby).

Management center 500 includes a processor 501, a storage 502, and a communication module 503. Processor 501 includes, for example, a central processing unit (CPU). Storage 502 is configured such that information put thereinto can be stored therein. Storage 502 may include a hard disk (HD) drive or a solid state drive (SSD). Communication module 503 is connected to a communication network NW, for example, through a wire. Each of server 150 and server 250 is also connected to communication network NW, for example, through a wire. Management center 500, insurance server 600, server 150, and server 250 are configured to communicate with one another over communication network NW. Communication network NW is a wide range network constructed, for example, of the Internet and a wireless base station. Communication network NW may include a cellular network.

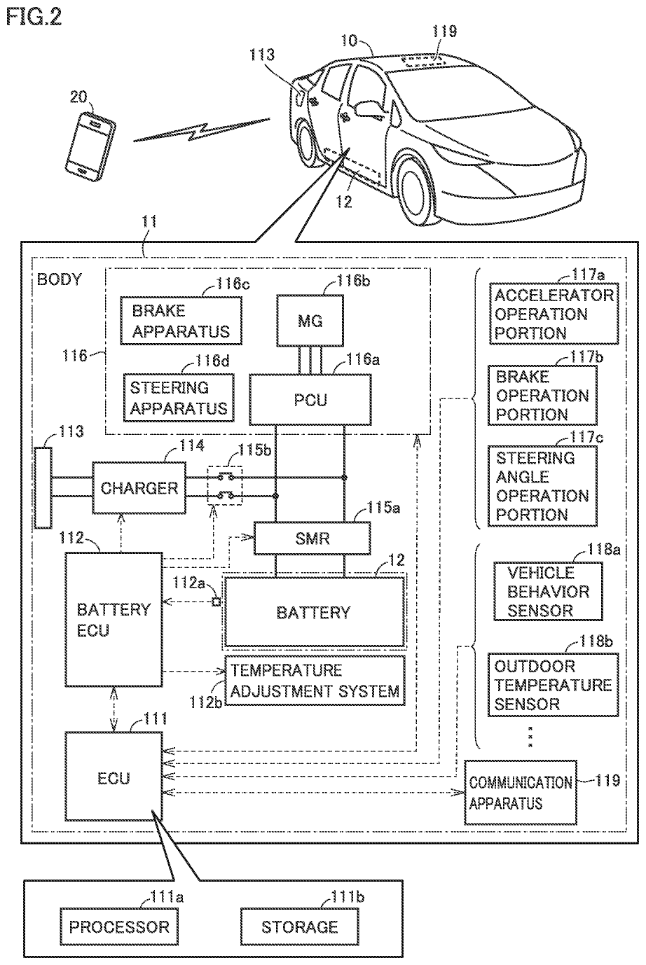

A vehicle provided by dealer 100 is referred to as a “vehicle 10” below. Vehicle 10 according to this embodiment is vehicle A or vehicle B shown in FIG. 1. FIG. 2 is a diagram for illustrating a configuration of vehicle 10.

Referring to FIG. 2, vehicle 10 includes a body 11 and a battery 12 mounted on body 11. Vehicle 10 is configured to travel with electric power in battery 12. Vehicle 10 is, for example, a BEV not provided with an internal combustion engine. A known power storage for a vehicle (for example, a liquid secondary battery or an all-solid-state secondary battery) can be adopted as battery 12. Examples of the secondary battery for the vehicle include a lithium ion battery and a nickel metal hydride battery. A plurality of secondary batteries may form a battery pack. Battery 12 corresponds to an exemplary “power storage” according to the present disclosure.

Body 11 includes an ECU 111, a battery ECU 112, a battery management system (BMS) 112a, a temperature adjustment system 112b, an inlet 113, a charger 114, a system main relay (SMR) 115a, a charging relay 115b, a drive apparatus 116, an accelerator operation portion 117a, a brake operation portion 117b, a steering angle operation portion 117c, a vehicle behavior sensor 118a, an outdoor temperature sensor 118b, and a communication apparatus 119. Drive apparatus 116 includes a power control unit (PCU) 116a, a motor generator (MG) 116b, a brake apparatus 116c, and a steering apparatus 116d. The ECU means an electronic control unit. A control system including each ECU mounted on body 11 is supplied with electric power from a not-shown auxiliary battery. Body 11 may further include a human machine interface (HMI) that accepts an input other than a drive operation from a vehicle user.

ECU 111 is a computer including a processor 111a and a storage 111b. A program executed by processor 111a and information (for example, a map, a mathematical expression, and various parameters) used by the program are stored in storage 111b. Various types of information on vehicle 10 are further held in storage 111b. Such information is updated in accordance with a status of vehicle 10. Though FIG. 2 does not show a configuration of battery ECU 112, battery ECU 112 is also a computer similar in hardware configuration to ECU 111. ECU 111 and battery ECU 112 are configured to communicate with each other. These ECUs are connected to each other, for example, over a controller area network (CAN).

Battery management system (BMS) 112a includes a sensor that detects a state (for example, a temperature, a current, and a voltage) of battery 12. A result of detection by BMS 112a is outputted to battery ECU 112. Temperature adjustment system 112b adjusts a temperature of battery 12. Temperature adjustment system 112b may include at least one of a heater and a cooling apparatus. A type of cooling may be water cooling or another type. Temperature adjustment system 112b is controlled by battery ECU 112.

Vehicle 10 is configured to be capable of external charging (charging of battery 12 with electric power from the outside of the vehicle). Inlet 113 is constructed such that a plug (for example, a connector of a charging cable) of electric vehicle supply equipment (EVSE) is attachable thereto and removable therefrom. Charger 114 includes a power conversion circuit for external charging. Charger 114 may include at least one of a direct-current (DC)/DC conversion circuit and an alternating-current (AC)/DC conversion circuit. Charging relay 115b switches between connection and disconnection of a charging line. In the example shown in FIG. 2, the charging line including inlet 113, charger 114, and charging relay 115b is connected between SMR 115a and PCU 116a. Without being limited as such, the charging line may be connected between battery 12 and SMR 115a. The configuration shown in FIG. 2 may be modified to be capable of external power feed (power feed from battery 12 to the outside of the vehicle). For example, charger 114 shown in FIG. 2 may be changed to a charger-discharger.

SMR 115a switches between connection and disconnection of an electrical path from battery 12 to PCU 116a. While vehicle 10 travels, SMR 115a is connected and charging relay 115b is disconnected. While electric power is exchanged between battery 12 and inlet 113, both of SMR 115a and charging relay 115b are connected. Each of charger 114, SMR 115a, and charging relay 115b is controlled by battery ECU 112. Battery ECU 112 receives a control command from ECU 111.

In drive apparatus 116, PCU 116a and MG 116b function as an accelerator apparatus. Brake apparatus 116c includes, for example, a braking apparatus (including a brake pad) provided in each wheel of vehicle 10 and an actuator that drives the braking apparatus. In this embodiment, a hydraulic foot brake apparatus is adopted as brake apparatus 116c. Steering apparatus 116d includes, for example, an electric power steering (EPS) and an actuator that drives the EPS.

PCU 116a is controlled by ECU 111 to drive MG 116b with electric power supplied from battery 12. PCU 116a includes, for example, an inverter and a DC/DC converter. MG 116b functions as a motor for travel of vehicle 10. MG 116b is driven by PCU 116a to rotate a drive wheel of vehicle 10. Alternatively, MG 116b carries out regeneration during braking (deceleration) of vehicle 10 and outputs generated electric power to battery 12. Vehicle 10 may include any number of motors for travel.

Each of accelerator operation portion 117a, brake operation portion 117b, and steering angle operation portion 117c is provided with a sensor that detects an amount of operation by the vehicle user, and a detected value thereof is outputted to ECU 111. An operation portion operated by the vehicle user may be in any form (a button, a pedal, a lever, or the like). For example, accelerator operation portion 117a, brake operation portion 117b, and steering angle operation portion 117c may be implemented by an accelerator pedal, a brake pedal, and a steering wheel, respectively.

Drive apparatus 116 is configured to control a behavior (acceleration, deceleration, and turning) of vehicle 10 in accordance with a control command from ECU 111. ECU 111 determines the control command to drive apparatus 116 based on an amount of operation onto accelerator operation portion 117a, brake operation portion 117b, and steering angle operation portion 117c. Each of the accelerator apparatus (PCU 116a), brake apparatus 116c, and steering apparatus 116d is controlled by ECU 111.

Vehicle behavior sensor 118a includes a position sensor, a vehicle speed sensor, and an acceleration sensor. Vehicle behavior sensor 118a further includes a travel meter that measures at least one of a travel distance and a time period of travel. Vehicle behavior sensor 118a may include an odometer as the travel meter. The position sensor may detect a position (for example, a longitude and a latitude) of vehicle 10 with the use of a global positioning system (GPS). ECU 111 can detect a position, a speed, an acceleration, and a history of travel of vehicle 10 (specifically, a distance traveled by vehicle 10 or a time period elapsed during travel of vehicle 10) based on an output from vehicle behavior sensor 118a. Vehicle behavior sensor 118a may further include at least one of an inertial measurement unit (IMU) and a yaw rate sensor. Outdoor temperature sensor 118b is configured to detect an outdoor temperature of vehicle 10 (a temperature of outdoor air around vehicle 10).

Communication apparatus 119 includes a communication interface (I/F) for access to communication network NW through wireless communication. Communication apparatus 119 may include a telematics control unit (TCU) or a data communication module (DCM) for wireless communication. Communication apparatus 119 further includes a communication I/F for wireless communication with each of server 250 and portable terminal 20. ECU 111 is configured to communicate with each of management center 500, server 250, and portable terminal 20 through communication apparatus 119. ECU 111 may communicate with each of server 150 and insurance server 600 through communication apparatus 119.

Portable terminal 20 is configured as being portable by the user. Portable terminal 20 is operated while it is carried by the user (vehicle manager) of vehicle 10. In this embodiment, a smartphone equipped with a touch panel display is adopted as portable terminal 20. The smartphone contains a computer and performs a speaker function. Without being limited as such, any terminal portable by the user of vehicle 10 can be adopted as portable terminal 20. For example, a laptop computer, a tablet terminal, a portable game console, a wearable device (a smartwatch, smartglasses, smart gloves, or the like), and an electronic key can also be adopted as portable terminal 20.

Application software (which is referred to as a “mobile app” below) for using a service provided by management center 500 is installed in portable terminal 20. With the mobile app, identification information (a terminal ID) of portable terminal 20 is registered in management center 500 in association with identification information (a vehicle ID) of corresponding vehicle 10. Portable terminal 20 can exchange information with management center 500 through the mobile app. Portable terminal 20 may be configured to communicate with each of insurance server 600, server 250, and server 150 (FIG. 1).

In vehicle 10, ECU 111 is responsible for integrated control of the entire vehicle. ECU 111 obtains results of detection from various sensors (including vehicle behavior sensor 118a and outdoor temperature sensor 118b) mounted on vehicle 10. ECU 111 obtains information also from each of battery ECU 112, accelerator operation portion 117a, brake operation portion 117b, steering angle operation portion 117c, and communication apparatus 119. Battery ECU 112 obtains a state (for example, a temperature, a current, a voltage, and an SOC) of battery 12 based on an output from BMS 112a and outputs the obtained state of battery 12 to ECU 111. Vehicle information obtained by ECU 111 is stored in storage 111b.

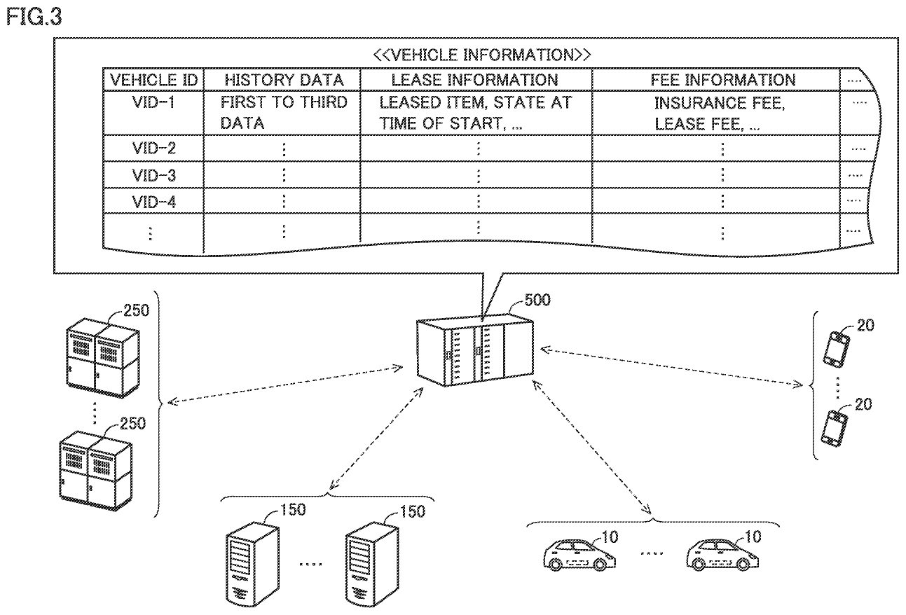

FIG. 3 is a diagram for illustrating information managed by management center 500 according to this embodiment. Referring to FIG. 3, identification information (vehicle ID) of each vehicle provided by the automaker through dealer 100 to the user is registered in advance in management center 500. The vehicle ID may be a vehicle Identification number (VIN). Information on each vehicle (vehicle information) is stored in storage 502 (FIG. 1) of management center 500, as being distinguished based on the vehicle ID. Management center 500 manages data included in the vehicle information as being distinguished based on an assessment period (for example, a month preceding the lease period) set for the lease period. Therefore, management center 500 can calculate the insurance fee and the lease fee for the lease period based on data during the assessment period.

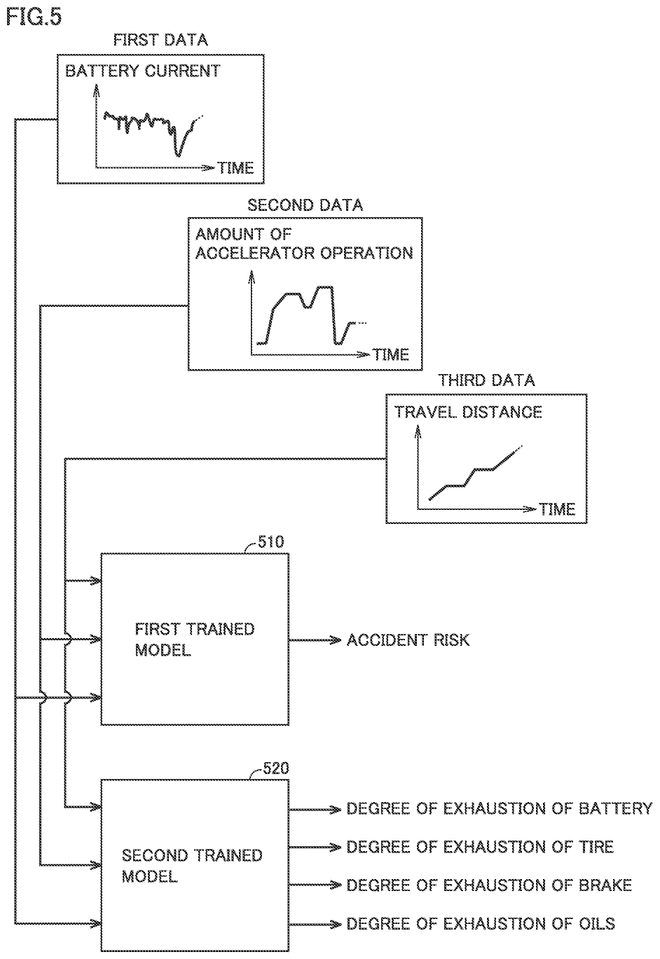

The vehicle information includes history data, lease information, fee information, user terminal information, and battery information. The history data is data detected by the sensors provided in vehicle 10. In this embodiment, the history data includes first to third data which will be described later (see FIG. 5). The user terminal information represents identification information and a communication address of a user terminal (for example, portable terminal 20) for each vehicle. The battery information represents specifications (for example, a capacity in an initial state, charging performance, and discharging performance) of battery 12 mounted on vehicle 10.

The lease information represents a type of a leased consumable and a state at the time of start. The leased consumable is a consumable provided to vehicle 10 by lease. In this embodiment, battery 12, a tire, a brake component (for example, a brake pad included in brake apparatus 116c), and oils (for example, lubricating oil, hydraulic fluid, and refrigerant used in temperature adjustment system 112b and drive apparatus 116) are registered in management center 500 as the consumables of vehicle 10. The lease information represents which of a plurality of registered consumables (battery 12, the tire, the brake component, and oils) falls under the leased consumable or does not fall under the leased consumable. The lease information further represents the state at the time of start of the leased consumable, which is more specifically a degree of exhaustion of the leased consumable at the time of start of assessment (timing of start of the assessment period).

The lease information associated with vehicle A (partial lease vehicle) indicates that battery 12 falls under the leased consumable and indicates a degree of exhaustion of battery 12 at the time of start of assessment. The lease information associated with vehicle B (full lease vehicle) indicates that all of battery 12, the tire, the brake component, and oils fall under the leased consumables and indicates the degree of exhaustion of the leased consumables at the time of start of assessment. The degree of exhaustion indicates a degree of lowering in performance of a consumable. For example, the degree of exhaustion of battery 12 may be expressed by a rate of lowering in capacity or an internal resistance. The degree of exhaustion of each of the brake pad and the tire may be expressed by an amount of wear. The degree of exhaustion of oils may be expressed by a physical property such as a viscosity.

The fee information corresponds to information on a fee paid by a vehicle user to the automaker. The fee information includes an insurance fee and a lease fee. The insurance fee corresponds to a fee paid by the vehicle user to receive the insurance service. The lease fee corresponds to a fee paid by the vehicle user to receive the lease service. In this embodiment, the fee is counted as the number of points (pt). A large number of points means a high fee. The point may be handled as a virtual currency or converted to a general currency (for example, dollar, renminbi, or yen). The point may be converted to an item or a right (for example, a right to receive a service in conformity with the number of points).

The lease system according to this embodiment includes a plurality of dealers 100 (each including server 150), a plurality of BSta's 200 (each including server 250), and a plurality of vehicles 10, and management center 500 is configured to communicate with all of them. Management center 500 is further configured to communicate also with a user terminal (portable terminal 20) for each vehicle.

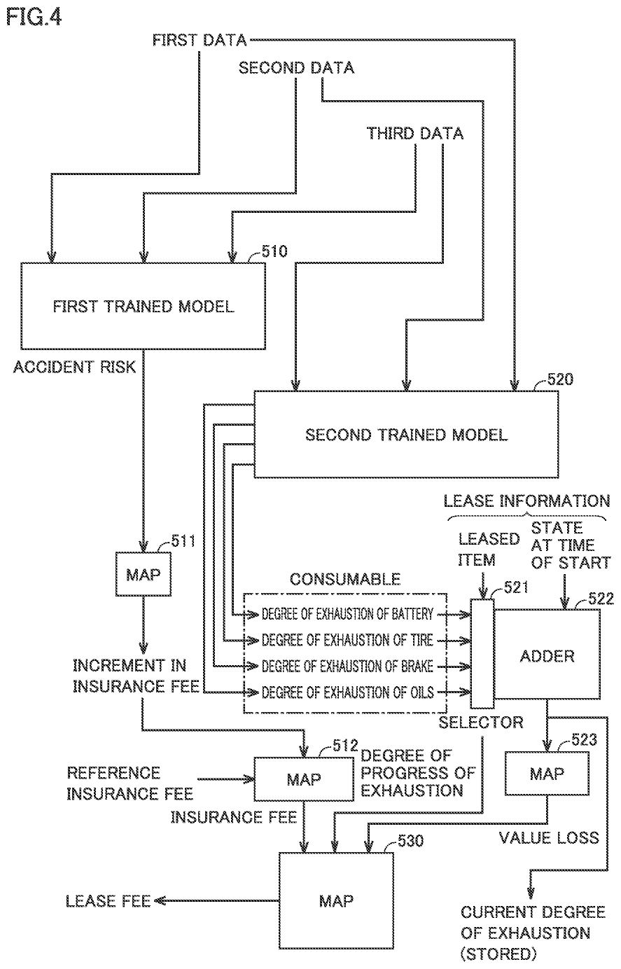

FIG. 4 is a diagram for illustrating a method of obtaining a lease fee. Referring to FIG. 4, a first trained model 510, maps 511 and 512, a second trained model 520, a map 523, and a map 530 are stored in storage 502 (FIG. 1) of management center 500. Management center 500 includes a selector 521 and an adder 522. Each of selector 521 and adder 522 may be implemented by a program or electronic circuitry. Management center 500 can obtain a lease fee for reception of the lease service described previously with a method which will be described below, in connection with vehicle 10 (the partial lease vehicle or the full lease vehicle) provided by the lease service. Vehicle 10 subjected to processing is referred to as a “subject vehicle” below.

FIG. 5 is a diagram for illustrating first trained model 510 and second trained model 520. Referring to FIG. 5 together with FIGS. 1 to 4, management center 500 inputs first to third data which will be described below to each of first trained model 510 and second trained model 520.

The first data represents a history of a current that flows in battery 12 (power storage) mounted on the subject vehicle. The first data may be, for example, a graph (a “battery current-time” graph) showing transition of the current in battery 12. The second data represents a history of an amount of accelerator operation (an amount of operation onto accelerator operation portion 117a) in the subject vehicle. The second data may be, for example, a graph (an “amount of accelerator operation-time” graph) showing transition of the amount of accelerator operation in the subject vehicle. The amount of accelerator operation may be expressed by an accelerator position. The third data represents a travel distance or a time period of travel of the subject vehicle. The third data may be, for example, a graph (a “cumulative travel distance-time” graph) showing transition of the cumulative travel distance of the subject vehicle. In this embodiment, the third data representing the cumulative travel distance of the subject vehicle is adopted. Without being limited as such, the third data representing the cumulative time period of travel of the subject vehicle may be adopted. It is not essential to represent the travel distance or the time period of travel by a cumulative value, and it may be represented by an average value (for example, a travel distance or a time period of travel per one day). Each of the first to third data may be image data for showing a corresponding graph. Alternatively, each of the first to third data may be coordinate data (for example, data of a XY coordinate system) for showing a corresponding graph.

When first trained model 510 receives input of first input data during a first period, it outputs an accident risk assessed in connection with the first period. In this embodiment, the first data, the second data, and the third data described above in connection with the subject vehicle are adopted as the first input data. The accident risk outputted from first trained model 510 represents possibility of an accident of the subject vehicle.

First trained model 510 outputs a higher accident risk as the cumulative travel distance represented by the inputted third data is longer. When the inputted first and second data include a pattern high in accident risk (which is referred to as an “accident drive pattern” below), first trained model 510 outputs the high accident risk. As the first and second data include a larger number of accident drive patterns, first trained model 510 outputs the higher accident risk. When the inputted first and second data do not include the accident drive pattern, first trained model 510 outputs the accident risk lower than in an example where the inputted first and second data include the accident drive pattern. Examples of the accident drive pattern include a pattern exhibiting hard braking, a pattern exhibiting sudden start, a pattern exhibiting frequent acceleration and deceleration within a short period of time, and a pattern exhibiting tailgating. The accident drive pattern may be a pattern including a feature value high in accident risk, the feature value being extracted by deep learning which will be described later.

When second trained model 520 receives input of second input data during a second period, it outputs the degree of progress of exhaustion of each consumable during the second period. In this embodiment, the first data, the second data, and the third data in connection with the subject vehicle are adopted as the second input data. In other words, the second input data is the same as the first input data. The consumables assessed by second trained model 520 in this embodiment include the battery (power storage), the tire, the brake component, and oils registered in management center 500. Second trained model 520 outputs the degree of progress of exhaustion of each consumable (battery 12, the tire, the brake component, and oils) of the subject vehicle during the second period. The degree of progress of exhaustion during the second period (that is, the degree by which exhaustion progresses during the second period) is outputted for each consumable.

Second trained model 520 outputs a higher degree of progress of exhaustion as the cumulative travel distance represented by the inputted third data is longer. When the inputted first and second data include a pattern that accelerates exhaustion of the consumable (which is referred to as an “exhaustion pattern” below), second trained model 520 outputs a higher degree of progress of exhaustion. The exhaustion pattern is different for each consumable. As the first and second data include a larger number of exhaustion patterns, second trained model 520 outputs the higher degree of progress of exhaustion. When the inputted first and second data do not include the exhaustion pattern, second trained model 520 outputs the degree of progress of exhaustion lower than in an example where the inputted first and second data include the exhaustion pattern. Examples of the exhaustion pattern include the patterns exemplified as the accident drive patterns described previously. In other words, drive of a car that raises the accident risk tends to exhaust car components. The degree of progress of exhaustion, however, is different for each component. For example, the pattern exhibiting the hard braking tends to exhaust, for example, the tire and the brake component. The pattern exhibiting the sudden start tends to exhaust, for example, battery 12. The pattern exhibiting frequent acceleration and deceleration within a short period of time tends to exhaust, in particular, battery 12 and oils. The exhaustion pattern may be a pattern including a feature value higher in degree of progress of exhaustion, the feature value being extracted for each consumable by deep learning which will be described later.

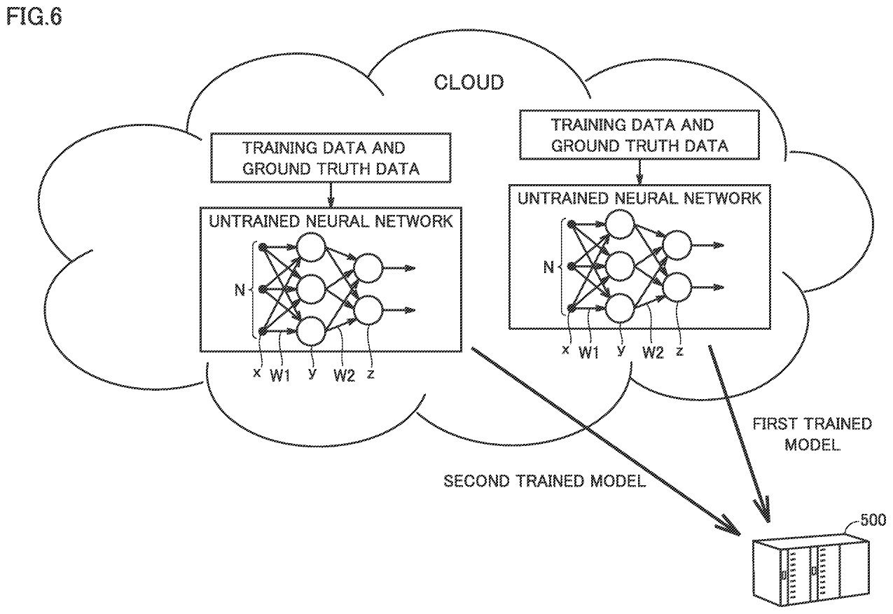

FIG. 6 is a diagram for illustrating a method of generating first trained model 510 and second trained model 520. Referring to FIG. 6, in this embodiment, each trained model is generated by machine training using artificial intelligence (AI). Specifically, each trained model is generated by preparation of an untrained neural network and training of the neural network with a training system implemented on the cloud.

The neural network includes an input layer x, a hidden layer y, and an output layer z. Input layer x includes nodes corresponding in number (N) to input data (first or second input data). For example, in a form where image data is adopted as input data, the number of nodes in input layer x is set to the number corresponding to the number of pixels in the input data. The number of nodes of output layer z is determined in accordance with the number of necessary outputs. Any number of nodes of output layer z can be set. Though FIG. 6 shows only a single hidden layer y, any number of hidden layers can be set.

A training system includes a training tool, for example, for generation of a teacher label, training, optimization of the neural network, assessment of performance, and compression and speedup of a model. For example, deep learning or deep reinforcement learning may be adopted as a learning method. According to the deep learning, a higher-order feature value can automatically be extracted from a lower-order feature value via a large number of hidden layers in the neural network that simulates activities of human nerves. The deep reinforcement learning is a method which is combination of capability of the deep learning for extraction of a feature value and capability of reinforcement learning for general-purpose optimization. The training system may further include such a simulation tool as software in the loop simulation (SILS) or hardware in the loop simulation (HILS). The training system may further include a software development tool such as a code review tool, a test tool, a compiler, a bug tracking tool, and a version management tool. The training system may further include a software distribution tool such as an over the air (OTA) updating tool.

As a result of supervised machine training of the neural network with the use of the training system, a weight W1 between input layer x and hidden layer y and a weight w2 between hidden layer y and output layer z are adjusted to achieve matching between a target output from the neural network and an actual output therefrom. Repetition of adjustment of weights W1 and W2 by a teaching signal can enhance accuracy in estimation by the neural network.

Specifically, the training system uses the first data, the second data, and the third data in connection with the subject vehicle and ground truth data in connection with the accident risk of the subject vehicle, to carry out supervised machine training on the untrained neural network to thereby generate the trained neural network capable of highly accurately estimating the accident risk. The ground truth data in connection with the accident risk may be data indicating whether or not an accident occurred. Alternatively, the ground truth data in connection with the accident risk may be data indicating a degree of matching of input data with the actual accident drive pattern such as data indicating a degree (or a deviation) of matching of the input data with the first data, the second data, and the third data when hard braking, sudden start, highly frequent acceleration and deceleration, or tailgating actually occurs. The trained neural network thus generated corresponds to first trained model 510. When the first input data (the first data, the second data, and the third data) during the first period is inputted as a result of training processing, first trained model 510 machine-trained to output the accident risk assessed in connection with the first period is obtained.

The training system uses the first data, the second data, and the third data in connection with the subject vehicle and ground truth data in connection with the degree of progress of exhaustion of each consumable (the battery, the tire, the brake component, and oils) of the subject vehicle, to carry out supervised machine training on the untrained neural network to thereby generate the trained neural network capable of highly accurately estimating the degree of progress of exhaustion of each consumable. The ground truth data in connection with the degree of progress of exhaustion of each consumable may be data indicating an actual degree of progress of exhaustion according to the input data for each consumable. Alternatively, the ground truth data in connection with the degree of progress of exhaustion of each consumable may be data indicating a degree (or a deviation) of matching of the input data with the actual exhaustion pattern (for example, the exhaustion pattern confirmed in experiments or simulation for each consumable). The trained neural network thus generated corresponds to second trained model 520. When the second input data (the first data, the second data, and the third data) during the second period is inputted as a result of training processing, second trained model 520 machine-trained to output the degree of progress of exhaustion of each consumable (the battery, the tire, the brake component, and oils) during the second period is obtained.

The training system may extract teaching data (training data and ground truth data thereof) from big data (statistical data) collected from a large number of vehicles, to carry out supervised machine training on the untrained neural network. The training system may collect the first data, the second data, and the third data for training (training data) and the ground truth data thereof by analysis of the big data and simulation. The training system may use such a method as cluster analysis, dimensionality reduction, a decision tree, or a support vector machine (SVM) in analysis of the big data. Without being limited as such, the user may obtain training data and ground truth data thereof and provide them to the training system.

In this embodiment, the first data, the second data, and the third data are adopted as the input data (training data). The first data on a battery current corresponds to a direct element that directly affects the degree of progress of exhaustion of the battery and corresponds to an indirect element that indirectly affects the accident risk. The second data on the amount of accelerator operation corresponds to a direct element that directly affects each of the accident risk and the degree of progress of exhaustion of a mechanical component (the tire, the brake component, and oils) and corresponds to an indirect element that indirectly affects the degree of progress of exhaustion of the battery. The third data on the travel distance or the time period of travel functions as an integral element on all of the accident risk and the degree of progress of exhaustion of each consumable (the battery, the tire, the brake component, and oils). The accident risk and the degree of progress of exhaustion of each consumable are each higher as each of the travel distance and the time period of travel is longer. As set forth above, the first data, the second data, and the third data function as the direct element, the indirect element, and the integral element on each output value. As a result of training of a model with such three types of data (the first data, the second data, and the third data) being used as the input data (training data), first trained model 510 and second trained model 520 that highly accurately output an output value are generated. With the input data (the first data, the second data, and the third data) common to first trained model 510 and second trained model 520, each trained model can be generated with a small amount of training data.

In this embodiment, management center 500 obtains first trained model 510 and second trained model 520 generated as above from the training system on the cloud, and has each trained model stored in storage 502 (FIG. 1). It is not essential, however, to implement the training system on the cloud. The training system may be implemented in management center 500.

Referring again to FIG. 4, when management center 500 inputs the previously-described first to third data (see FIG. 5) in connection with the subject vehicle into first trained model 510, first trained model 510 outputs the accident risk of the subject vehicle. Specifically, when the first to third data during the assessment period are inputted to first trained model 510, first trained model 510 outputs data indicating the accident risk (possibility of an accident) of the subject vehicle assessed in connection with the assessment period. The accident risk outputted from first trained model 510 is inputted to map 511. Map 511 then outputs an increment in insurance fee in accordance with the inputted accident risk. Map 511 defines such relation that the insurance fee is more inexpensive as the accident risk is lower. Map 511 outputs to map 512, the increment in insurance fee which is larger as the accident risk inputted from first trained model 510 is higher.

Map 512 outputs to map 530 as the insurance fee, for example, a value calculated by addition of a prescribed reference insurance fee and the increment in insurance fee inputted from map 511. The reference insurance fee may be fixed or variable in accordance with the lease type. In other words, the reference insurance fee may be different between vehicle A and vehicle B. Map 512 may output to map 530 as the insurance fee, a value calculated by multiplying the reference insurance fee by the increment in insurance fee (for example, a coefficient indicating the increment in insurance fee) from map 511.

When management center 500 inputs the previously-described first to third data (see FIG. 5) in connection with the subject vehicle to second trained model 520, second trained model 520 outputs the degree of progress of exhaustion of each consumable (battery 12, the tire, the brake component, and oils) of the subject vehicle. Specifically, when the first to third data during the assessment period are inputted to second trained model 520, second trained model 520 outputs data indicating the degree of progress of exhaustion during the assessment period (the degree by which exhaustion progresses during the assessment period) for each consumable of the subject vehicle. The data (the degree of progress of exhaustion of each consumable of the subject vehicle during the assessment period) outputted from second trained model 520 is inputted to selector 521.

Selector 521 receives input of the lease information (see FIG. 3) of the subject vehicle, in addition to the degree of progress of exhaustion of each consumable of the subject vehicle during the assessment period. Selector 521 selects data indicating the degree of progress of exhaustion of the leased consumable of the subject vehicle from the data inputted from second trained model 520, and outputs the selected data (that is, the degree of progress of exhaustion of the leased consumable of the subject vehicle). Selector 521 identifies a type of the leased consumable of the subject vehicle based on the lease information of the subject vehicle. When the subject vehicle falls under vehicle A (partial lease vehicle), selector 521 outputs the degree of progress of exhaustion of battery 12 mounted on the subject vehicle. When the subject vehicle falls under vehicle B (full lease vehicle), selector 521 outputs the degree of progress of exhaustion of each of battery 12, the tire, the brake component, and oils mounted on the subject vehicle. The data (the degree of progress of exhaustion of the leased consumable of the subject vehicle during the assessment period) outputted from selector 521 is inputted to each of adder 522 and map 530.

Adder 522 outputs to map 523 as the current degree of exhaustion of the leased consumable, a value calculated by addition of the degree of exhaustion at the time of start of assessment (the degree of exhaustion at the timing of start of the assessment period) of the leased consumable indicated by the lease information (FIG. 3) of the subject vehicle and the degree of progress of exhaustion of the leased consumable of the subject vehicle during the assessment period outputted from selector 521. In this embodiment, the degree of exhaustion of the leased consumable is expressed, with the timing of start of lease (initial state) being defined as the reference (0). In other words, the current degree of exhaustion of the leased consumable corresponds to the degree of progress of exhaustion from the timing of start of lease of the leased consumable until the current time point.

Map 523 outputs to map 530, a value loss of the leased consumable in accordance with the current degree of exhaustion of the leased consumable. The value loss of the leased consumable represents a lost value of the leased consumable with the timing of start of lease (initial state) being defined as the reference (0). As the degree of exhaustion from timing of start of lease of the leased consumable is higher, the value loss of the leased consumable is larger. Map 523 outputs the value loss in accordance with the current degree of exhaustion of the leased consumable of the subject vehicle. When the subject vehicle falls under vehicle B (full lease vehicle), a total value of the value losses of a plurality of leased consumables is outputted from map 523.

Map 530 defines relation among the insurance fee, the degree of progress of exhaustion during the assessment period, the value loss of the leased consumable, and the lease fee. Map 530 outputs the lease fee (pt/month) that is higher as the insurance fee inputted from map 512 is higher, the degree of progress of exhaustion during the assessment period inputted from selector 521 is higher, and the value loss of the leased consumable inputted from map 523 is smaller (that is, the value of the leased consumable is higher).

Each map shown in FIG. 4 should only define relation between an input value and an output value, or it may be expressed in a mathematical expression. Management center 500 may be configured to update each map shown in FIG. 4. The insurance fee and the lease fee can thus readily be revised.

When dealer 100 leases a vehicle, contract information (for example, the lease information and specification information) in connection with that vehicle is inputted to server 150 and transmitted from server 150 to management center 500. In this embodiment, unless a contractor (a vehicle user) shows its intention for cancellation, each time the lease period elapses, contract contents (including the lease fee) during a next lease period are determined, and the lease contract is automatically renewed. When timing to renew the lease contract comes, management center 500 determines the lease fee. Server 150 manages the lease period of each vehicle, and when the lease period of any vehicle expires, server 150 may request management center 500 to determine the lease fee for that vehicle. Management center 500 may start a series of processing shown in FIG. 7 which will be described below, in response to the request from server 150.

FIG. 7 is a flowchart showing processing involved with determination of a lease fee. Each step in the flowchart is simply denoted as “S” below. Management center 500 determines the lease fee (including the insurance fee) for the lease period based on data during the assessment period set before the lease period, through the series of processing shown in FIG. 7. In this embodiment, a month preceding the lease period (one month immediately before the lease period) is defined as the assessment period. Management center 500 performs the series of processing shown in FIG. 7, for example, at timing of start of a next lease period after lapse of the lease period. The lease period that has elapsed corresponds to the assessment period for the next lease period. In the series of processing shown in FIG. 7, a vehicle involved with the renewed lease contract is referred to as a “subject vehicle.” The subject vehicle is any of vehicles A and B (FIG. 1).

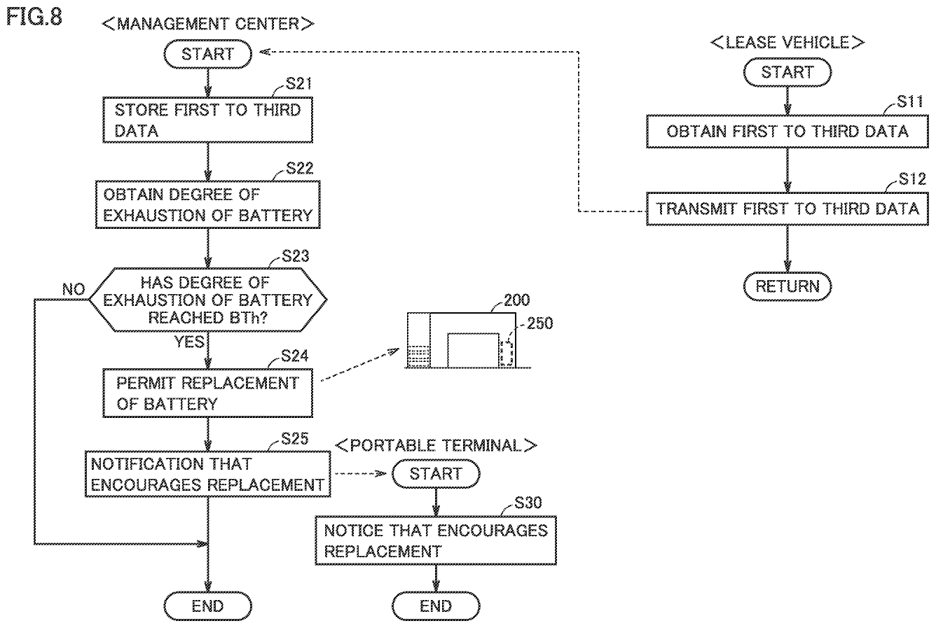

Referring to FIG. 7, in S110, management center 500 reads from storage 502, the lease information (the type of the leased consumable and the degree of exhaustion of the leased consumable at the timing of start of the assessment period) in connection with the subject vehicle and the first data, the second data, and the third data during the assessment period based on the identification information (vehicle ID) of the subject vehicle and obtains the lease fee with the method described previously (see FIG. 4) based on these types of information. Though details will be described later, vehicle 10 according to this embodiment sequentially transmits latest first data, second data, and third data to management center 500 in prescribed cycles (see FIG. 8). Management center 500 then has the first data, the second data, and the third data received from vehicle 10 stored in storage 502 in association with the identification information (vehicle ID) of vehicle 10. The first data, the second data, and the third data representing transition of the battery current, the amount of accelerator operation, and the cumulative travel distance during the assessment period are thus stored in storage 502.

Management center 500 determines the lease fee obtained by the configuration shown in FIG. 4 as the lease fee for a next lease period of the subject vehicle. When the subject vehicle falls under vehicle A, the lease fee to be paid by the user of vehicle 10A for rental of battery 12A for vehicle 10A shown in FIG. 1 is determined in processing in S110. Since the lease fee includes the insurance fee, the user of vehicle 10A can receive the insurance service (battery insurance) described previously by payment of the lease fee determined for vehicle 10A. When the subject vehicle falls under vehicle B, the lease fee to be paid by the user of vehicle 10B for rental of the entirety (body 11B and battery 12B) of vehicle 10B shown in FIG. 1 is determined in processing in S110. Since the lease fee includes the insurance fee, the user of vehicle 10B can receive the insurance service (the battery insurance and the body insurance) described previously by payment of the lease fee determined for vehicle 10B. Body 11B includes the tire, the brake component, and oils as the leased consumables.

Management center 500 obtains not only the lease fee for the next lease period but also the insurance fee for the next lease period as well as the accident risk assessed in connection with the assessment period, the degree of progress of exhaustion during the assessment period, and the value loss of the leased consumable owing to the configuration shown in FIG. 4 (including first trained model 510 and second trained model 520), and has the obtained information stored in storage 502 in association with the identification information (vehicle ID) of the subject vehicle. For example, the current degree of exhaustion of the leased consumable outputted from adder 522 is stored in storage 502 (FIG. 1) as the degree of exhaustion of the leased consumable at the timing of start of a next assessment period of the subject vehicle.

As described above, in storage 502 of the computer apparatus (management center 500) according to this embodiment, first trained model 510 machine-trained to output the accident risk assessed in connection with the assessment period when it receives input of the first input data including the first data, the second data, and the third data during the assessment period and second trained model 520 machine-trained to output the degree of progress of exhaustion of the consumable during the assessment period when it receives input of the second input data including the first data, the second data, and the third data during the assessment period are stored (see FIG. 4). Management center 500 (adder 522) then obtains the degree of exhaustion of the consumable based on the degree of progress of exhaustion of the consumable outputted from second trained model 520. According to management center 500 thus configured, each of the accident risk of vehicle 10 and the degree of exhaustion of the leased consumable can highly accurately be obtained.

In the leasing method according to this embodiment, when the body portion (body 11) except for the power storage of vehicle 10 is the property of the user of vehicle 10 and the power storage (battery 12) of vehicle 10 is provided to vehicle 10 by lease, management center 500 obtains the degree of exhaustion of battery 12. Specifically, selector 521 selects the degree of progress of exhaustion of battery 12 and adder 522 outputs the degree of exhaustion of battery 12. When both of the body portion (body 11) of vehicle 10 and the power storage (battery 12) are provided to vehicle 10 by lease, management center 500 obtains the degree of exhaustion of battery 12 and the degree of exhaustion of each consumable (the tire, the brake component, and oils) included in body 11. Specifically, selector 521 selects the degree of progress of exhaustion of each of battery 12, the tire, the brake component, and oils and adder 522 outputs the degree of exhaustion of each of battery 12, the tire, the brake component, and oils. According to such a method, appropriate obtainment of the degree of exhaustion of the leased consumable of each of the partial lease vehicle and the full lease vehicle is facilitated.

Furthermore, in the leasing method according to this embodiment, management center 500 sets the lease fee for the lease period to be more inexpensive as the accident risk of the leased consumable outputted from first trained model 510 is lower. Management center 500 sets the lease fee for the lease period to be more inexpensive as the degree of progress of exhaustion of the leased consumable outputted from second trained model 520 is lower. Management center 500 sets the lease fee for the lease period to be more inexpensive as the degree of exhaustion of the leased consumable outputted from adder 522 is higher.

According to the method, the lease fee on which the accident risk of vehicle 10, the degree of progress of exhaustion of the leased consumable, and the degree of exhaustion of the leased consumable are reflected can be obtained. When the rented power storage or the like fails due to an accident of vehicle 10, the lease company may sustain damages. In the method, in order to solve such a problem, the lease fee is varied in accordance with the accident risk, so that the compensation for the risk taken by the leasing company can be reflected on the lease fee. A system where the user rents a leased consumable by payment of the same lease fee both in a case where the degree of exhaustion of the leased consumable is high and in a case where the degree of exhaustion of the leased consumable is low may cause unfairness between users. In the method above, in order to solve such a problem, the lease fee is varied in accordance with the degree of exhaustion of the leased consumable, so that the value loss (depreciation) of the leased consumable can be reflected on the lease fee. When the degree of exhaustion of the leased consumable at the time of return is high, on the other hand, the leasing company may sustain damages. In the method, in order to solve such a problem, the lease fee is set to be higher as the degree of progress of exhaustion of the leased consumable is higher, so that excessive exhaustion of the leased consumable can be suppressed. Thus, reuse of the returned power storage or the like is facilitated.

In following S120, management center 500 determines a threshold value (which is denoted as “BTh” below) for battery replacement. BTh represents a threshold value of the degree of exhaustion of battery 12 and indicates timing of battery replacement (see FIG. 8). BTh is set to avoid excessive deterioration of battery 12. BTh may be fixed or variable. In this embodiment, management center 500 sets BTh which is lower as the degree of progress of exhaustion during the assessment period is higher. A rate of exhaustion of battery 12 is estimated to be higher as the degree of progress of exhaustion during the assessment period is higher. Setting of low BTh when the rate of exhaustion of battery 12 is high can suppress excessive deterioration of battery 12. Setting of low BTh allows early battery replacement. Thereafter, the process proceeds to S130.

In S130, management center 500 has the lease fee and BTh determined in the above-described processing in S110 and S120 stored in storage 502 in association with the identification information (vehicle ID) of the subject vehicle, and transmits them to server 150.

FIG. 8 is a flowchart showing processing involved with vehicle management (in particular, battery management) performed by management center 500 as well as vehicle 10 (vehicles A and B) and a user terminal thereof.

ECU 111 of vehicle 10 (vehicle A or B) repeatedly performs a series of processing in S11 and S12 which will be described below during a period (including standstill and travel of the vehicle) from start-up of a vehicle control system (including ECU 111) until shutdown thereof. In the series of processing shown in FIG. 8, vehicle 10 that performs such processing is referred to as a “subject vehicle.”

In S11, ECU 111 has the first data, the second data, and the third data (for example, data on the battery current, the amount of accelerator operation, and the cumulative travel distance shown in FIG. 5) recorded in storage 111b in association with time of detection, the first data, the second data, and the third data having been detected by the sensors (for example, BMS 112a, accelerator operation portion 117a, and vehicle behavior sensor 118a) provided in the subject vehicle. ECU 111 may express the battery current on a discharging side as a positive (+) value and express the battery current on a charging side as a negative (−) value. In succession, in S12, ECU 111 transmits the first data, the second data, and the third data recorded in storage 111b to management center 500, together with the identification information (vehicle ID) of the subject vehicle. In S12, ECU 111 may transmit another type of information on the subject vehicle in addition to the first to third data to management center 500. In this embodiment, in S12, ECU 111 transmits information indicating a current position of the subject vehicle to management center 500. As a result of processing in this S12, data recorded in storage 111b during a period from previous transmission (S12) until present transmission (S12) is transmitted to management center 500. When the processing in S12 is performed, the process returns to the initial step (S11). S11 and S12 are repeated in prescribed cycles.

When management center 500 receives the data (S12) from the subject vehicle, it starts a series of processing from S21 to S25. In S21, management center 500 has the latest first data, second data, and third data received from the subject vehicle stored in storage 502 in association with the identification information (vehicle ID) of the subject vehicle.

In following S22, management center 500 obtains the current degree of exhaustion of battery 12 of the subject vehicle with an assessment mechanism (the trained model, the map, and the like) shown in FIG. 4. Specifically, when the first data, the second data, and the third data during the period from start of assessment until the current time point are inputted to second trained model 520, adder 522 outputs the current degree of exhaustion of battery 12 of the subject vehicle.

In following S23, management center 500 determines whether or not the degree of exhaustion of battery 12 obtained in S22 has reached BTh (S120 in FIG. 7). When the degree of exhaustion of battery 12 obtained in S22 is equal to or more than BTh, determination as YES is made in S23 and processing in S24 and S25 which will be described below is performed. When the degree of exhaustion of battery 12 is lower than BTh (NO in S23), on the other hand, the series of processing from S21 to S25 ends without the processing in S24 and S25 being performed. Management center 500 may make determination as YES in S23 also when battery 12 is determined as having failed based on the first data.

In S24, management center 500 permits server 250 of at least one BSta 200 present around the subject vehicle to replace battery 12 mounted on the subject vehicle. At least one BSta 200 present around the subject vehicle may be single BSta 200 closest to a position of the subject vehicle or at least one BSta 200 present within a prescribed distance from the position of the subject vehicle. Management center 500 transmits a replacement permission signal including the identification information (vehicle ID) of the subject vehicle to server 250 of at least one BSta 200 present around the subject vehicle. This replacement permission signal indicates permission of replacement of the battery in the subject vehicle at BSta 200. Server 250 identifies the vehicle, the battery of which is to be replaced, based on the vehicle ID included in the replacement permission signal. The vehicle ID included in the replacement permission signal is registered in server 250, and replacement of the battery in the subject vehicle indicated by the vehicle ID is programmed in server 250. Server 250 can have programmed battery replacement carried out in processing shown in FIG. 9 which will be described later. When the battery is not replaced even after lapse of a prescribed period since programming of battery replacement, the programming may be canceled.

In following S25, management center 500 gives a notification (which is referred to as a “replacement notification” below) that encourages replacement of the battery under the insurance service to the user terminal (portable terminal 20) of the subject vehicle. When the processing in S25 is performed, the series of processing from S21 to S25 ends.

When portable terminal 20 corresponding to the user terminal of the subject vehicle receives the replacement notification, it performs processing in S30. In S30, portable terminal 20 performs notice processing to encourage the user of the subject vehicle to replace the battery. For example, portable terminal 20 may turn on a sound notifying the user of reception of the replacement notification and show a message that encourages the user to replace the battery.

The vehicle user encouraged to replace the battery may drive the subject vehicle toward BSta 200 (for example, closest BSta 200) around the same. FIG. 9 is a flowchart showing processing involved with battery replacement performed by the subject vehicle and a battery replacement station terminal (server 250).

Referring to FIG. 9 together with FIGS. 1 to 3, a series of processing from S310 to S380 is performed by ECU 111 of the subject vehicle. A series of processing from S410 to S470 is performed by server 250. Server 250 is configured to wirelessly communicate with portable terminal 20. Server 250 and portable terminal 20 may establish short-range communication, for example, through a wireless local area network (LAN) or communicate over communication network NW.

The subject vehicle arrives at BSta 200, and thereafter in S310, it transmits a signal requesting battery replacement (which is also referred to as a “request signal” below) to server 250. The request signal includes identification information (a vehicle ID) of the subject vehicle. Battery 12 yet to be replaced that is included in the subject vehicle is denoted as a “battery B1” below. The subject vehicle may request battery replacement (S310) in response to an instruction from a user.

In S410, server 250 that has received the request signal determines whether or not a prescribed replacement requirement in connection with the subject vehicle is satisfied. Specifically, server 250 determines whether or not the replacement requirement is satisfied based on whether or not the vehicle ID included in the request signal matches with the vehicle ID included in the replacement permission signal (S24 in FIG. 8). In other words, when the vehicle ID of the subject vehicle has been registered (programmed), the replacement requirement is satisfied, and when the vehicle ID of the subject vehicle has not been registered (programmed), the replacement requirement is not satisfied.

When the replacement requirement is satisfied in connection with the subject vehicle (YES in S410), in S420, server 250 sends a notification indicating permission to the subject vehicle, and thereafter the process proceeds to S440. When the replacement requirement is not satisfied in connection with the subject vehicle (NO in S410), on the other hand, in S430, server 250 sends a notification indicating non-permission to the subject vehicle, and thereafter the series of processing from S410 to S470 ends. In this case, the battery is not replaced.

The subject vehicle transmits the request signal (S310), and thereafter it waits for reply from server 250. When the subject vehicle receives the reply from server 250, in S320, it determines whether or not replacement of the battery has been permitted. When the subject vehicle receives the notification indicating permission (YES in S320), the process proceeds to S330. When the subject vehicle receives the notification indicating non-permission (NO in S320), on the other hand, the series of processing from S310 to S380 ends. In this case, the battery is not replaced.

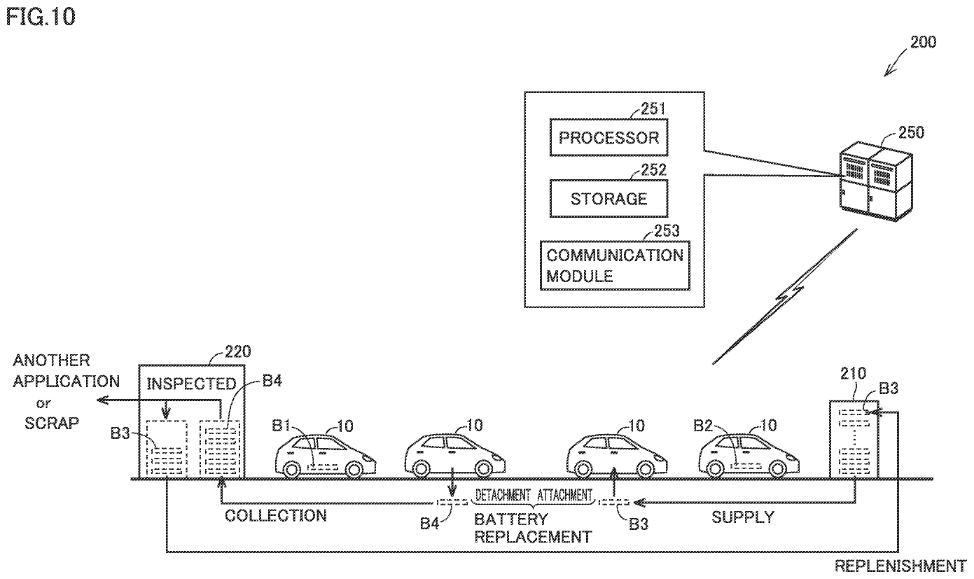

In S330 and S440, the battery is replaced in a procedure which will be described later (see FIG. 10). The subject vehicle and server 250 exchange information for replacement of the battery. Server 250 may obtain information (for example, specification information) on battery B1 from the subject vehicle.

Battery 12 attached to the subject vehicle as a result of battery replacement is denoted as a “battery B2” below. When replacement of the battery is completed, in S340, the subject vehicle inspects battery B2. In succession, in S350, the subject vehicle transmits a result of inspection to server 250. In succession, in S360, the subject vehicle determines whether or not the battery has successfully been replaced in accordance with the result of inspection. The subject vehicle determines that the battery has successfully been replaced unless abnormality (for example, defective connection or abnormal electrical performance) is found in the inspection, and determines that replacement of the battery has failed when abnormality is found in the inspection. Similarly, in S450, server 250 that has received the result of inspection also determines whether or not the battery has successfully been replaced in accordance with the result of inspection (normal/abnormal).

When the battery has successfully been replaced (YES in S360 and YES in S450), the subject vehicle and server 250 update the battery information (specification information or the like) held therein in S370 and S460, respectively, and thereafter the series of processing shown in FIG. 9 ends. When replacement of the battery has failed (NO in S360 and NO in S450), on the other hand, the subject vehicle and server 250 perform prescribed abnormality-addressing processing in S380 and S470, respectively. The abnormality-addressing processing may include processing for notifying the user of the subject vehicle of failure in replacement of the battery. The abnormality-addressing processing may include processing for notifying management center 500 of failure in replacement of the battery. The abnormality-addressing processing may include processing for once detaching battery B2 attached to the subject vehicle from the subject vehicle and redoing replacement of the battery. After the abnormality-addressing processing is performed, the series of processing shown in FIG. 9 ends. The abnormality-addressing processing can freely be set.

FIG. 10 is a diagram for illustrating a configuration and an operation of a battery replacement station (BSta 200) according to this embodiment.

Referring to FIG. 10, BSta 200 includes a storage apparatus 210, an inspection portion 220, and server 250. Storage apparatus 210 includes an accommodation portion (for example, a storage). Inspection portion 220 includes, for example, a charger-discharger, a measurement apparatus, and a categorization apparatus. BSta 200 further includes a transport apparatus that transports the power storage and a replacement apparatus that replaces the power storage. A type of transport may be a conveyor type or a type with the use of a delivery robot. Server 250 controls each of the transport apparatus and the replacement apparatus.

Server 250 includes a processor 251, a storage 252, and a communication module 253. Information on each battery present in BSta 200 is stored in storage 252 of server 250, as being distinguished based on identification information (a battery ID) of the battery. The battery information held by server 250 includes, for example, specifications (a capacity in an initial state, charging performance, and discharging performance), a status (for example, any one of yet-to-be-inspected/inspected (reuse/another application/scrap)/suppliable), the degree of exhaustion, and a state of charge (SOC). The SOC represents a remaining amount of stored power, and corresponds to a ratio of a current amount of stored power to an amount of stored power in a fully charged state. Examples of the degree of exhaustion include a rate of lowering in capacity and an internal resistance. A higher internal resistance of the power storage means a higher degree of exhaustion of the power storage. A higher rate of lowering in capacity of the power storage means a higher degree of exhaustion of the power storage. The rate of lowering in capacity of the power storage indicates, with the capacity of the power storage in the initial state (non-deteriorated state) being defined as the reference, how much the current capacity of the power storage is lower than a reference capacity (the capacity in the initial state). The capacity of the power storage corresponds to the amount of stored power in the fully charged state.

Server 250 may transmit to management center 500, information (a battery ID, specifications, the degree of exhaustion, and the like) on each battery B3 (suppliable power storage) accommodated in the accommodation portion of storage apparatus 210, together with position information of BSta 200. Management center 500 may manage inventory of batteries at each BSta 200 based on the battery information from server 250. The battery present in BSta 200 is a property of the automaker. A new battery may be supplied from a warehouse of the automaker to BSta 200 or a secondhand battery collected from vehicle 10 may be stored in BSta 200. Batteries may be transported among a plurality of BSta's 200.

The subject vehicle is parked at a prescribed position in BSta 200, and thereafter issues a request for battery replacement to server 250 (S310 in FIG. 9). In response to this request, server 250 starts control for battery replacement (S440 in FIG. 9). Server 250 has the battery of the subject vehicle replaced, for example, in a procedure as below.

Server 250 selects a battery (replacement battery) corresponding to battery B1 from among a plurality of batteries B3 accommodated in the accommodation portion of storage apparatus 210. Selected battery B3 is the same in specifications (for example, the capacity in the initial state, charging performance, and discharging performance) as battery B1. Battery B3, however, is lower in degree of exhaustion than battery B1. The SOC of battery B3 is equal to or higher than a prescribed SOC value (for example, 50%).

In succession, the replacement apparatus detaches battery B1 from the subject vehicle. The battery detached from the subject vehicle is denoted as a “battery B4” below. In succession, the transport apparatus transports (supplies) battery B3 from storage apparatus 210 to the replacement apparatus. In succession, the replacement apparatus attaches supplied battery B3 to the subject vehicle. Replacement of the battery of the subject vehicle is thus completed.

BSta 200 performs a process for reuse of battery B4 detached from the subject vehicle, in parallel to the battery replacement process above. When battery B4 is detached from the subject vehicle, server 250 starts control for battery reuse. The reuse process is performed, for example, in a procedure as below.

The transport apparatus transports (collects) battery B4 to inspection portion 220. In succession, inspection portion 220 inspects collected battery B4. The charger-discharger and the measurement apparatus in inspection portion 220 perform inspection. Battery B4 may be subjected to recovery processing (processing for lowering the degree of exhaustion) before inspection.

In the inspection, the charger-discharger has battery B4 discharged until the SOC attains, for example, to a prescribed first SOC value (for example, the SOC value indicating an empty state) or lower, and thereafter it has battery B4 charged until the SOC attains to a prescribed second SOC value (for example, the SOC value indicating the fully charged state) or higher. The measurement apparatus includes various sensors, and measures a state (for example, a temperature, a current, and a voltage) of battery B4 during charging and/or discharging. The measurement apparatus then detects the degree of exhaustion of battery B4 from measured data. The measurement apparatus may further include a camera for inspection of an appearance. The charger-discharger may repeat charging and discharging of battery B4 until the measurement apparatus obtains necessary inspection data.

When the inspection is completed, the categorization apparatus in inspection portion 220 categorizes battery B4 into a battery for reuse as a vehicle battery, a battery for use in another application (an application other than the application for the vehicle), and scrap, in accordance with a result of the inspection. Examples of another application include stationary use. The battery may be scrapped in any manner. In a scrap process, the battery may be disassembled to a material level to collect a recyclable material (resource) for reuse of the material (resource recycle). The categorization apparatus may categorize battery B4 having a significantly damaged appearance into a non-reusable battery (another application or scrap).

Battery B4 reusable as the vehicle battery is handled as battery B3 described previously. After the inspection, the transport apparatus transports battery B3 to storage apparatus 210. Storage apparatus 210 is replenished with transported battery B3. Inspected and charged battery B3 is thus set in storage apparatus 210 and becomes suppliable. Without being limited as such, storage apparatus 210 may be configured to charge inspected battery B3.

FIG. 10 shows an example where detachment of the battery and attachment of the battery are performed at different locations. The subject vehicle may be transported from a detachment position to an attachment position by a not-shown transport apparatus (for example, a transport apparatus of a conveyor type). Without being limited as such, detachment of the battery and attachment of the battery may be performed at the same location. The battery may be replaced (detached and attached) while the subject vehicle is at a standstill (for example, a parked state). It is not essential that the battery yet to be replaced and the replaced battery are the same in specifications. A vehicle-mounted battery may be replaced with a battery different in specifications. For example, the capacity of the vehicle-mounted battery may be increased by battery replacement.

As described above, the leasing method according to this embodiment includes processing shown in FIGS. 4 to 10. In this embodiment, management center 500 corresponds to an exemplary “computer apparatus” according to the present disclosure. The processing is performed by execution by at least one processor, of a program stored in at least one memory. The processing, however, may be performed by dedicated hardware (electronic circuitry) rather than software.

The leasing method according to this embodiment includes obtaining, by management center 500, first data representing a history of a current that flows in the power storage mounted on the vehicle (S12 and S21 in FIG. 8), obtaining, by management center 500, second data representing a history of an amount of accelerator operation in the vehicle (S12 and S21 in FIG. 8), obtaining, by management center 500, third data representing a travel distance or a time period of travel of the vehicle (S12 and S21 in FIG. 8), obtaining, by management center 500, the accident risk of the vehicle based on the first data, the second data, and the third data (S110 in FIG. 7), and obtaining, by management center 500, the degree of exhaustion of the leased consumable (the consumable provided to the vehicle by lease) including the power storage based on the first data, the second data, and the third data (S110 in FIGS. 7 and S22 in FIG. 8). According to such a method, the accident risk and the degree of lease exhaustion can properly be obtained with a small amount of data. Therefore, an amount of data exchanged between vehicle 10 and management center 500 can be small. The leasing company can know the current value of the leased consumable and possibility of deterioration (or failure) of the leased consumable in the future, and appropriate provision of the lease service is facilitated.

More specifically, the leasing method according to this embodiment further includes determining, by management center 500, a lease-associated cost based on the accident risk and the degree of lease exhaustion obtained as above (S110 in FIG. 7). The lease-associated cost includes the insurance fee paid by the user of the vehicle for reception of the insurance service relating to replacement of the power storage and the lease fee for the consumable paid by the user of the vehicle for rental of the leased consumable. In this embodiment, the lease fee outputted from map 530 shown in FIG. 4 corresponds to the lease-associated cost. Management center 500 sets the insurance fee to be more inexpensive as the accident risk of the vehicle is lower. Management center 500 sets the lease fee for the consumable to be more inexpensive as the degree of lease exhaustion is higher. According to such a method, appropriate determination of the insurance fee of the vehicle and the lease fee for the consumable is facilitated.

Furthermore, management center 500 determines timing of replacement of the battery based on the degree of lease exhaustion obtained as above (see S120 in FIGS. 7 and S22 to S25 in FIG. 8). Replacement of the battery at appropriate timing is thus facilitated. Management center 500 may give the user terminal (for example, portable terminal 20) of vehicle 10, advice about safe drive based on the accident risk obtained as above. In the embodiment, vehicle 10 voluntarily transmits vehicle information (including the first data, the second data, and the third data) to management center 500 (see FIG. 8). Without being limited as such, vehicle 10 may transmit the vehicle information (including the first data, the second data, and the third data) to management center 500 in response to a request from management center 500.

Each of the input data (first input data) to first trained model 510 and the input data (second input data) to second trained model 520 is not limited to the first data, the second data, and the third data described previously, and another type of data may be added to such data. For example, the input data (first and second input data) to each trained model may further include history data on at least one of a battery temperature, a battery voltage, a total amount of discharging by the battery, a battery SOC, an outdoor temperature, a vehicle speed, and an acceleration of vehicle 10, in addition to the first data, the second data, and the third data described previously.

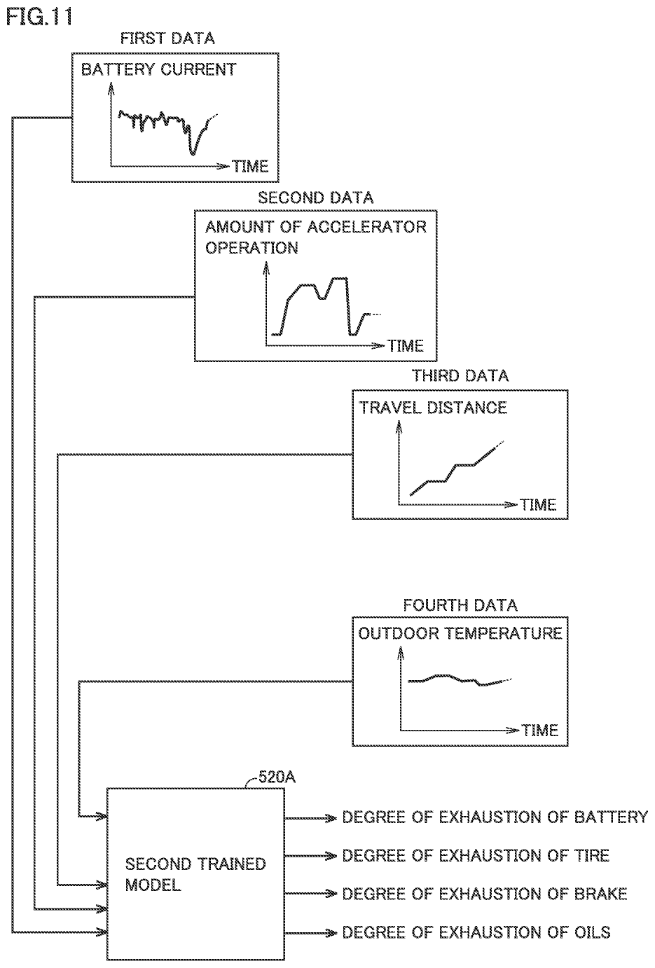

FIG. 11 is a diagram showing a modification of second trained model 520 shown in FIG. 5. Referring to FIG. 11, a second trained model 520A according to this modification is also generated, for example, by machine training of the neural network, similarly to second trained model 520 shown in FIG. 5. Second trained model 520A, however, outputs the degree of progress of exhaustion of each consumable (the battery, the tire, the brake component, and oils) of vehicle 10 during the second period when it receives input of second input data including the first data, the second data, the third data, and fourth data during the second period. The fourth data is data representing a history of an outdoor temperature of vehicle 10. For example, outdoor temperature sensor 118b shown in FIG. 2 detects the outdoor temperature of vehicle 10. The fourth data may be, for example, a graph (an “outdoor temperature-time” graph) showing transition of the outdoor temperature of vehicle 10. The outdoor temperature of vehicle 10 functions as an integral element with respect to the degree of exhaustion of each consumable mounted on vehicle 10. As the time period for which the consumable is used at a temperature out of a normal range is longer, the degree of exhaustion of the consumable is higher. As a result of machine training of a model with a plurality of types of integral elements, second trained model 520A that highly accurately outputs the degree of progress of exhaustion of each consumable is more readily obtained.

The consumable of vehicle 10 registered in management center 500 is not limited to battery 12, the tire, the brake component, and oils, and can be modified as appropriate. Any of the tire, the brake component, and oils may not be registered, or another consumable (a motor, a gear, or the like) may be added.

In the embodiment, a length (unit period) of the lease period is set to one month. Without being limited as such, the unit period can freely be set, and a period longer than one month (for example, three months, six months, or one year) may be set. The assessment period can also be changed as appropriate. The assessment period should only be a period preceding the lease period and any period can be set. For example, the entire period of use (a period from start of initial lease until renewal of the lease contract) in the past may be defined as the assessment period. It is not essential that the lease fee includes the insurance fee. Timing of renewal of the lease contract may be different from timing of renewal of an insurance contract. Management center 500 may obtain necessary information with the assessment mechanism shown in FIG. 4 at each timing.

Functions performed by management center 500 in the embodiment may be performed by server 150 (dealer terminal). Server 150 instead of management center 500 may function as the “computer apparatus” according to the present disclosure. Processing flows shown in FIGS. 7 to 9 can be modified as appropriate. For example, depending on an object, the order of processing may be changed or an unnecessary step may be omitted. Contents in any processing may be modified.

In this embodiment, management center 500, insurance server 600, server 150, and server 250 are each an on-premise server. Without being limited as such, the function of each server may be implemented on the cloud by cloud computing. In other words, these servers may be cloud servers. A location where the lease service is provided is not limited to dealer 100. For example, management center 500 may provide the lease service on-line (for example, on the cloud). Only a single type of lease (for example, the partial lease type) may be provided.

The battery replacement requirement (S410 in FIG. 9) can be modified as appropriate. The computer apparatus may permit battery replacement for vehicle 10 that has been involved in an accident. The computer apparatus (for example, management center 500) may transmit a replacement permission signal including the identification information of vehicle 10 that has been involved in the accident to server 250 of at least one BSta 200 when it receives a notice about occurrence of the accident of vehicle 10. Though only the battery is replaced in the embodiment, a battery pack including the battery and accessories thereof (for example, at least one of the battery ECU, the BMS, the temperature adjustment system, and the SMR) may collectively be replaced.

The vehicle may be an xEV (electrically powered vehicle) other than the BEV. The vehicle may include an internal combustion engine. The vehicle is not limited to a four-wheel passenger car, but may be a bus or a truck, or an xEV with three wheels or at least five wheels. The vehicle may be provided with a solar panel. The vehicle may be configured to wirelessly be chargeable. The vehicle may be configured to be able to autonomous drive or may perform a flying function. The vehicle may be a vehicle (for example, a robo-taxi, an automated guided vehicle, or an agricultural machine) that can travel without human intervention.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A leasing method comprising:
obtaining first data representing a history of a current that flows in a power storage mounted on a vehicle;
obtaining second data representing a history of an amount of accelerator operation in the vehicle;
obtaining third data representing a travel distance or a time period of travel of the vehicle;
obtaining an accident risk of the vehicle based on the first data, the second data, and the third data; and
obtaining a degree of exhaustion of a consumable including the power storage based on the first data, the second data, and the third data, the consumable being provided to the vehicle by lease.

2. The leasing method according to claim 1, further comprising determining a lease-associated cost based on the accident risk and the degree of exhaustion, wherein
the lease-associated cost includes an insurance fee paid by a user of the vehicle for reception of an insurance service relating to replacement of the power storage and a lease fee paid by the user of the vehicle for rental of the consumable, and
the determining a lease-associated cost includes
setting the insurance fee to be more inexpensive as the accident risk of the vehicle is lower, and
setting the lease fee to be more inexpensive as the degree of exhaustion of the consumable is higher.

3. The leasing method according to claim 1, wherein
the obtaining a degree of exhaustion of a consumable includes
obtaining the degree of exhaustion of the power storage when a body portion except for the power storage of the vehicle is a property of a user of the vehicle and the power storage of the vehicle is provided to the vehicle by lease, and
obtaining the degree of exhaustion of the power storage and the degree of exhaustion of each consumable included in the body portion when both of the body portion of the vehicle and the power storage are provided to the vehicle by lease.

4. A computer apparatus comprising:
a processor; and
a storage where a program causing the processor to perform the leasing method according to claim 1 is stored.

5. The computer apparatus according to claim 4, wherein
a first trained model and a second trained model are further stored in the storage,
the first trained model being machine-trained to output the accident risk assessed in connection with a first period when the first trained model receives input of first input data including the first data, the second data, and the third data during the first period,
the second trained model being machine-trained to output a degree of progress of exhaustion of the consumable during a second period when the second trained model receives input of second input data including the first data, the second data, and the third data during the second period, and
the computer apparatus obtains the degree of exhaustion of the consumable based on the degree of progress of exhaustion of the consumable outputted from the second trained model.

6. The computer apparatus according to claim 5, wherein
each of the first period and the second period is an assessment period set before a lease period, and
the computer apparatus is configured to
set a lease fee for the lease period to be more inexpensive as the accident risk of the consumable outputted from the first trained model is lower,
set the lease fee for the lease period to be more inexpensive as the degree of progress of exhaustion of the consumable outputted from the second trained model is lower, and
set the lease fee for the lease period to be more inexpensive as the degree of exhaustion of the consumable is higher.

7. The computer apparatus according to claim 5, wherein
the second input data further includes fourth data representing a history of an outdoor temperature of the vehicle.

8. A lease system comprising:
the computer apparatus according to claim 4; and
a vehicle that transmits the first data, the second data, and the third data to the computer apparatus.

9. The lease system according to claim 8, further comprising a plurality of replacement stations where a power storage for a vehicle is replaced, wherein
the computer apparatus is configured to permit at least one replacement station, when a degree of exhaustion of a power storage mounted on the vehicle becomes equal to or more than a prescribed value, to replace the power storage.
